(19) United States
(12) Patent Application Publication
(10) Pub. No.: US 2025/0360877 A1
(43) Pub. Date: Nov. 27, 2025

(54) EXTRUDED RUNNING BOARD FOR A VEHICLE

(71) Applicant: Arctic Cat Inc., Thief River Falls, MN (US)

(72) Inventors: Steven Janzow, Thief River Falls, MN (US); Benjamin Langaas, Thief River Falls, MN (US)

(73) Assignee: Arctic Cat Inc., Thief River Falls, MN (US)

(21) Appl. No.: 19/215,175

(22) Filed: May 21, 2025

Related U.S. Application Data
(60) Provisional application No. 63/651,068, filed on May 23, 2024.

(51) Int. Cl. B60R 3/00; B62M 27/02

(52) U.S. Cl. CPC B60R 3/002; B62M 27/02; B62M 2027/028

(57) ABSTRACT

A running board assembly includes a mounting bracket, a support, and a running board. The mounting bracket is configured to detachably couple to a first portion of the snowmobile. The support has a first end, a second end, and a running board interface positioned between the first end and the second end. The first end is detachably coupled to the mounting bracket. The second end is configured to detachably couple to a second portion of the snowmobile. The running board is detachably coupled to and supported by the mounting bracket and the running board interface of the support. The running board has a support surface defining a plurality of apertures forming a honey-comb shaped profile.

### CROSS-REFERENCE TO RELATED PATENT APPLICATION

This application claims the benefit of and priority to U.S. Provisional Patent Application No. 63/651,068, filed May 23, 2024, which is incorporated herein by reference in its entirety.

### BACKGROUND

Vehicles, such as snowmobiles, may include running boards along the sides thereof to help riders get onto the vehicles and support the fee of the riders while riding the vehicles.

### SUMMARY

One embodiment relates to a running board assembly. The running board assembly includes a mounting bracket, a support, and a running board. The mounting bracket is configured to detachably couple to a first portion of the snowmobile. The support has a first end, a second end, and a running board interface positioned between the first end and the second end. The first end is detachably coupled to the mounting bracket. The second end is configured to detachably couple to a second portion of the snowmobile. The running board is detachably coupled to and supported by the mounting bracket and the running board interface of the support. The running board has a support surface defining a plurality of apertures forming a honey-comb shaped profile.

Another embodiment relates to a running board assembly. The running board assembly includes a mounting bracket, a support, and a running board. The mounting bracket is configured to detachably couple to a first portion of a vehicle. The support has a first end, a second end, and a running board interface positioned between the first end and the second end. The first end is detachably coupled to the mounting bracket. The second end is configured to detachably couple to a second portion of the vehicle. The running board includes a support surface and a flange positioned along a lateral edge of the support surface. The support surface is configured to detachably couple to the mounting bracket and the flange is configured to engage with the running board interface of the support. The running board includes a first plurality of protrusions spaced along a longitudinal length of and extending upward from the flange. The running board includes a second plurality of protrusions extending upward from the support surface.

Still another embodiment relates to a running board assembly. The running board assembly includes a mounting bracket, a support, a running board, and a toe stop. The mounting bracket is configured to detachably couple to a first portion of a vehicle. The support has a first end, a second end, and a running board interface positioned between the first end and the second end. The first end is detachably coupled to the mounting bracket. The second end is configured to detachably couple to a second portion of the vehicle. The running board is detachably coupled to and supported by the mounting bracket and the running board interface of the support. The running board has a support surface defining a plurality of apertures forming a honey-comb shaped profile. The toe stop is detachably coupled to the running board and configured to detachably couple to a third portion of the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a side view of a vehicle, according to an exemplary embodiment.

FIG. 2 is a schematic block diagram of the vehicle of FIG. 1, according to an exemplary embodiment.

FIG. 3 is top view of the vehicle of FIG. 1, according to an exemplary embodiment.

FIG. 4 is a perspective view of a running board assembly of the vehicle of FIG. 1, according to an exemplary embodiment.

FIG. 5 is a perspective view of the running board assembly of FIG. 4 on the vehicle of FIG. 1, according to an exemplary embodiment.

FIG. 6 is another perspective view of the running board assembly of FIG. 4 on the vehicle of FIG. 1, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle (e.g., a snowmobile) includes a running board assembly on each side (e.g., lateral side) of the vehicle. The running board assembly includes one or more components, such as a support member coupling the running board assembly to the vehicle, a running board supported by and coupled to the support member, and a toe stop. The one or more components of the running board assembly can be detachably coupled to the vehicle and/or the other components of the running board assembly to allow one or more components of the running board assembly to be easily removed and/or replaced. In some embodiments, the running board assembly includes a mounting member to couple a portion of the running board assembly to the vehicle. In some embodiments, one or more components of the running board assembly are made of a metal material (e.g., extruded aluminum, molded metal, or other metal material) and/or a composite material (e.g., carbon fiber or other composite material). In some embodiments, one or more components of the running board assembly include or define a pattern, a series of through-holes, a texture, or a structure, such as a honey-comb structure, that contributes to strengthening the running board assembly, optimizing drainage and/or snowfall through the running board assembly, and/or minimal weight addition to the vehicle.

### Overall Vehicle

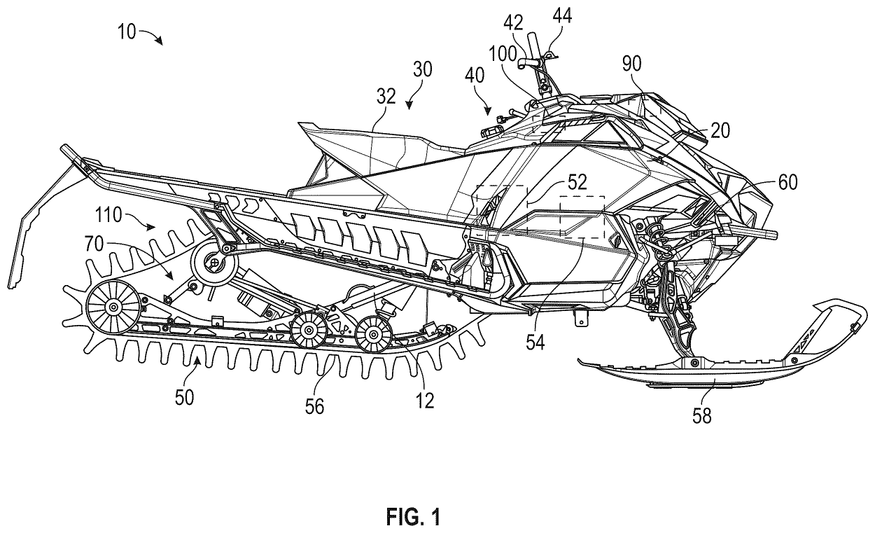

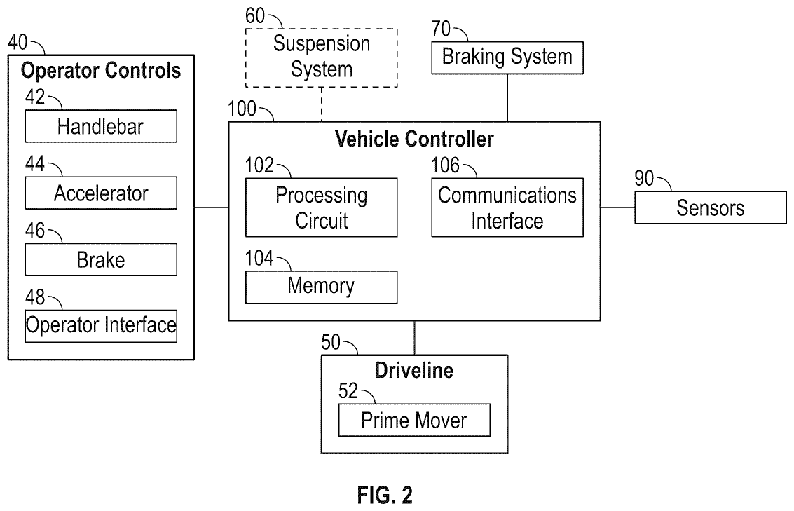

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a vehicle control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is a tracked, winter-focused off-road machine or vehicle configured to be operated on a snowy and/or icy surface (e.g., operated in snow, on ice, etc.). In some embodiments, the tracked, winter-focused off-road machine or vehicle is a lightweight or recreational machine or vehicle such as a snowmobile, a snow bike, a snow scooter, a snow all-terrain vehicle (“ATV”), a snow utility task vehicle (“UTV”), a snow plow machine, and/or another type of lightweight or recreational machine configured to be operated on a snowy and/or icy surface. In other embodiments, the tracked, snow-focused off-road machine or vehicle is a large machine or vehicle such as a snowcat, a snow groomer, a snowplow machine, a tractor, and/or another type of large machine or vehicle configured to be operated on a snowy and/or icy surface. In still other embodiments, the vehicle 10 is a non-tracked, off-road machine or vehicle such as an ATV, a UTV, a dirt bike, and/or another type of non-tracked, off-road machine or vehicle.

According to the exemplary embodiment shown in FIG. 1, the occupant seating area 30 includes a first seat, shown as operator seat 32, configured to support an operator of the vehicle 10. In some embodiments, the occupant seating area 30 includes a double seat configured to support the operator of the vehicle 10 and a passenger of the vehicle 10 behind the operator, or a triple seat configured to support the operator of the vehicle 10 and two passengers of the vehicle 10 behind the operator. In some embodiments, the occupant seating area 30 includes a second seat positioned rearward of or to the side of the operator seat 32. The second seat may be configured to support passengers of the vehicle 10. In some embodiments, in addition to or in place of the second seat, the vehicle 10 includes one or more rear accessories. Such rear accessories may include a ski rack, a bed, a cargo body (e.g., for a storage, etc.), and/or other rear accessories. In some embodiments, as shown in FIG. 1, the vehicle 10 includes one or more support assemblies, shown as running board assembly 110, positioned to at least partially support the operator of the vehicle 10 and/or one or more passengers of the vehicle 10.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a handlebar, a steering column, a handlebar assembly, joystick(s), a steering wheel, etc.), shown as handlebar 42, an accelerator interface (e.g., a pedal, a throttle, a throttle lever, etc.), shown as accelerator 44, a braking interface (e.g., a brake pedal, a brake lever, a brake arm, etc.), shown as brake 46, and one or more additional interfaces (e.g., a light control interface, an operational mode interface, etc.), shown as operator interfaces 48. The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., tracks, treads, axles, differentials, etc.), shown as rear tractive assembly 56, and a second tractive assembly (e.g., skis, runners, slides, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system.

According to the exemplary embodiment shown in FIG. 1, the rear tractive assembly 56 includes a rear tractive element that is configured as a track and the front tractive assembly 58 includes front tractive elements configured as skis. For example, the rear tractive element may be configured as a track configured to engage a snowy surface in order to drive the vehicle 10 and the front skis may be configured to slide or glide along the snowy surface. In some embodiments, the rear tractive assembly 56 includes a plurality of the rear tractive elements configured as tracks. In some embodiments, the front tractive assembly 58 includes front tractive elements that are configured as tracks. In other embodiments, the front tractive assembly 58 and the rear tractive assembly 56 include tractive elements that are configured as wheels.

According to an exemplary embodiment, the prime mover 52 is configured to provide power to drive the rear tractive assembly 56 (e.g., to provide rear-track drive, etc.). In some embodiments, the prime mover 52 is configured to provide power to drive the rear tractive assembly 56 and/or the front tractive assembly 58 (e.g., to provide front-track drive, to provide all-track drive, etc.). In some embodiments, the driveline 50 includes a transmission device (e.g., a gearbox, a continuous variable transmission (“CVT”), etc.) positioned between (a) the prime mover 52 and (b) the rear tractive assembly 56. In a non-track arrangement, the rear tractive assembly 56 may include a drive shaft, a differential, and/or an axle. In such non-track arrangement, the rear tractive assembly 56 includes two axles or a tandem axle arrangement. According to an exemplary embodiment, the front tractive assembly 58 is steerable (e.g., using the handlebar 42). In some embodiments, the rear tractive assembly 56 is additionally or alternatively steerable. In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first of the prime movers 52 that drives a first one of the rear tractive elements and a second of the prime movers 52 that drives a second one of the rear tractive elements when the rear tractive assembly 56 includes two rear tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include one or more rear braking components positioned to facilitate braking one or more components of the rear tractive assembly 56 (e.g., the rear axle, the rear tractive elements, etc.). In some embodiments (e.g., embodiments with two rear tractive elements), the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), suspension sensor(s), wheel/track sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the handlebar 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Extruded Running Board

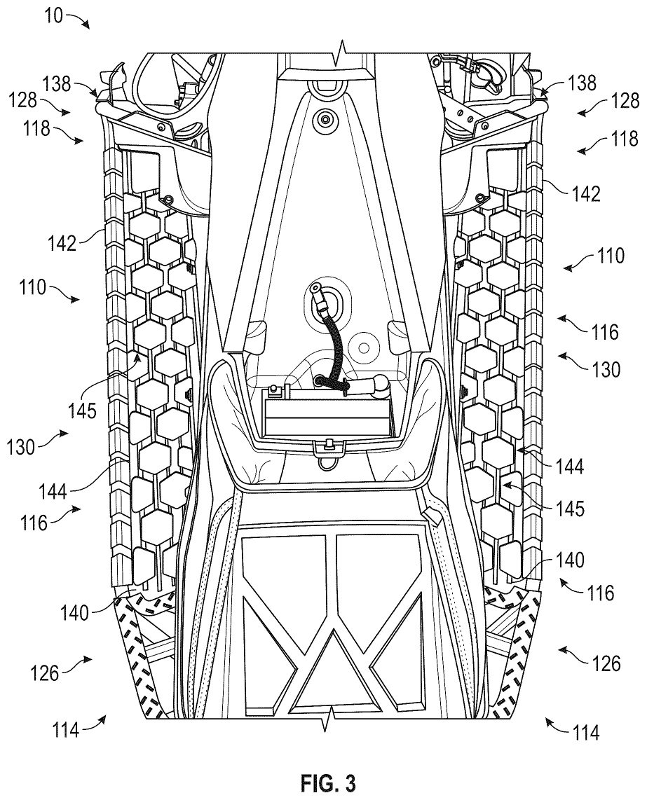

Referring generally to FIGS. 3-6, the vehicle 10 includes one or more running board assemblies on each side (e.g., lateral side) of the vehicle 10. The running board assembly may include one or more components such as a support member coupling the running board assembly to the vehicle 10, a running board supported by and coupled to the support member, and a toe stop. The one or more components of the running board assembly may be detachably coupled to the vehicle 10 and/or the other components to allow one or more components of the running board assembly to be easily removed and/or replaced. In some embodiments, the running board assembly includes a mounting member to couple a portion of the running board assembly to the vehicle 10. In some embodiments, one or more components of the running board assembly are made of a metal material (e.g., extruded aluminum, molded metal, or other metal material) and/or a composite material (e.g., carbon fiber or other composite material). In some embodiments, one or more components of the running board assembly include or define a pattern, a series of through-holes, a texture, or a structure, such as a honey-comb structure, that contributes to strengthening the running board assembly, optimizing drainage and/or snowfall through the running board assembly, and/or minimizing weight addition to the vehicle 10.

As shown in FIGS. 3-6, the vehicle 10 includes two running board assemblies 110, one extending along each lateral side of the occupant seating area 30. Each running board assembly 110 includes a first support or mounting member (e.g., bracket, plate, tunnel siding, etc.), shown as mounting bracket 112; a second support or mounting member (e.g., a rail, a tube, a frame, etc.), shown as structural support 114, having a first end (e.g., a rear end) coupled to the mounting bracket 112; a platform, shown as running board 116, coupled to and supported by the mounting bracket 112 and the structural support 114; and a retainer (e.g., toe holder, foot stop, etc.), shown as toe stop 118, positioned along the running board 116. According to an exemplary embodiment, the mounting bracket 112 is configured to couple the running board assembly 110 to a portion (e.g., a tunnel) of the body 20 and/or the frame 12 of the vehicle 10. As shown in FIGS. 3, 5, and 6, an opposing second end (e.g., a front end) of the structural support 114 is configured to couple the body 20 and/or the frame 12 of the vehicle 10.

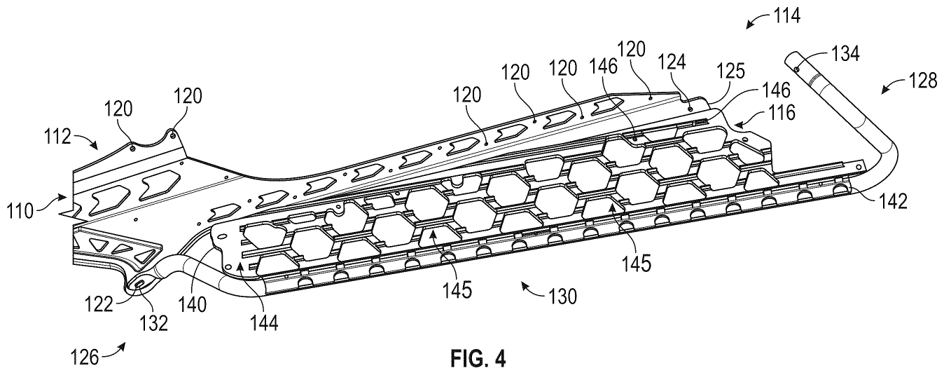

As shown in FIG. 4, the mounting bracket 112 defines a plurality of first apertures, shown as mounting aperture 120, along a longitudinal length thereof. According to an exemplary embodiment, the mounting apertures 120 are configured (e.g., sized, positioned, etc.) to receive a mounting fastener to detachably couple the mounting bracket 112 to the body 20 and/or the frame 12 of the vehicle 10. As shown in FIG. 4, the mounting bracket 112 defines one or more second apertures, shown as structural support aperture 122, positioned proximate a first end (e.g., a rear end) thereof. According to an exemplary embodiment, the structural support aperture 122 is configured (e.g., sized, positioned, etc.) to receive a structural support fastener to couple the first end of the structural support 114 to the mounting bracket 112 and, in some embodiments, to the body 20 and/or the frame 12 of the vehicle 10. As shown in FIG. 4, the mounting bracket 112 defines one or more third apertures, shown as toe stop aperture 124, positioned proximate an opposing second end (e.g., a front end) thereof. According to an exemplary embodiment, the toe stop aperture 124 is configured (e.g., sized, positioned, etc.) to receive a toe stop fastener to couple the toe stop 118 to the mounting bracket 112. In some embodiments, one or more of the mounting apertures 120, the structural support aperture 122, and/or the toe stop aperture 124 can coincide (e.g., overlap, overlay, or otherwise substantially similar) to mount the components of the running board assembly 110 to the vehicle 10. As shown in FIG. 4, the mounting bracket 112 includes a running board interface, shown as mounting plate 125, configured to provide a surface for an inner edge of the running board 116 to engage the mounting bracket 112. In some embodiments, the mounting plate 125 defines a plurality of running board apertures along a longitudinal length thereof. According to an exemplary embodiment, the running board apertures are configured (e.g., sized, positioned, etc.) to receive a mounting fastener to detachably couple the running board 116 to the mounting bracket 112. The mounting plate 125 contributes to easy assembly and/or disassembly of the running board 116 in the running board assembly 110, as described in more detail below.

As shown in FIGS. 3-6, the structural support 114 has a first portion (e.g., rear portion or end, first curved portion), shown as rear portion 126, a second portion (e.g., front portion or end, second curved portion), shown as front portion 128, and a third portion (e.g., running board interface, middle portion), shown as middle portion 130, extending between and continuous with the rear portion 126 to the front portion 128. The rear portion 126 and the front portion 128 are configured or shaped to engage at least one of the mounting bracket 112 or the vehicle 10. The rear portion 126 and the front portion 128 have a curved profile or shape.

As shown in FIG. 4, the rear portion 126 defines one or more first apertures, shown as structural support aperture 132, configured (e.g., sized, positioned, etc.) to align with the structural support aperture 122 of the mounting bracket 112. According to an exemplary embodiment, the structural support aperture 122 and the structural support aperture 132 cooperatively receive the structural support fastener to couple the structural support 114 to (a) the mounting bracket 112 and (b) the body 20 and/or the frame 12 of the vehicle 10. In some embodiments, the structural support fastener is received by the structural support aperture 132 to couple the structural support 114 directly to the body 20 and/or the frame 12 of the vehicle 10.

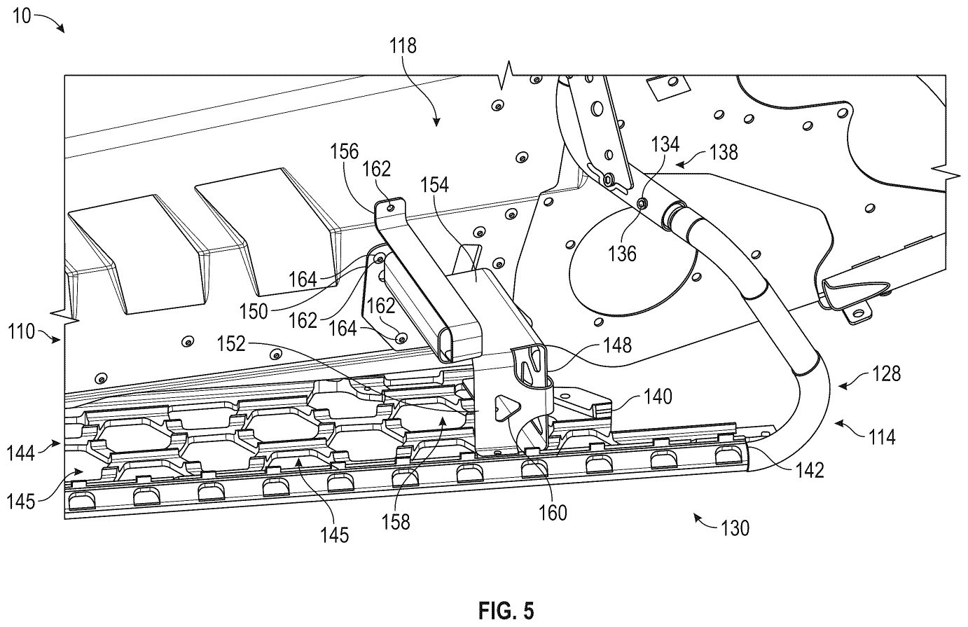

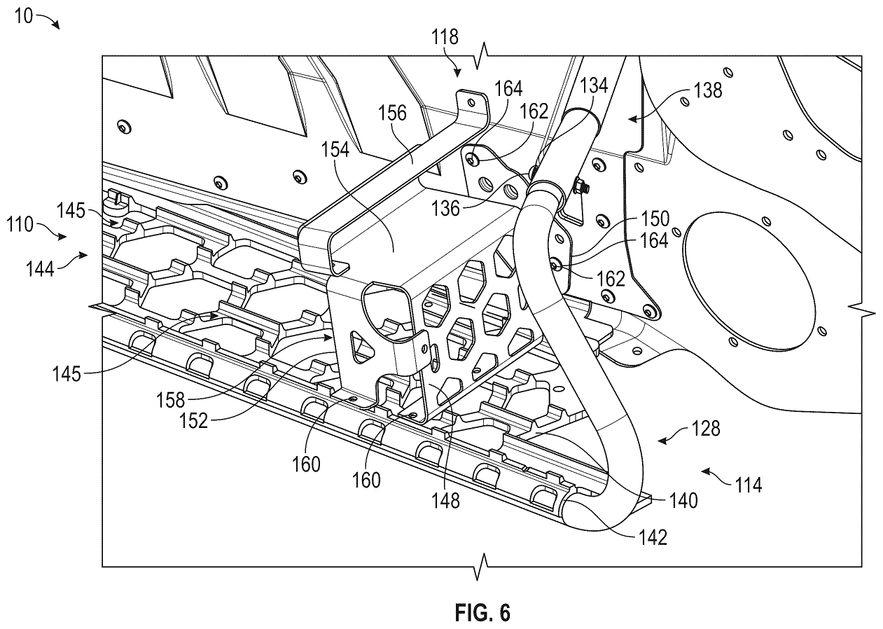

As shown in FIGS. 5 and 6, the front portion 128 of the structural support 114 defines a second aperture, shown as linking aperture 134, configured (e.g., sized, positioned, etc.) to receive a second fastener, shown as linking fastener 136, to couple the front portion 128 of structural support 114 to a linking member, shown as link 138. The link 138 is configured to couple the structural support 114 to the body 20 and/or the frame 12 of the vehicle 10. In some embodiments, the link 138 defines an opening in an end thereof that is configured to receive a portion of the front portion 128 of the structural support 114 therein. In some embodiments, the link 138 is continuous or integrally formed with the front portion 128 of structural support 114. In some embodiment, the rear portion 126, the front portion 128, the middle portion 130, and the link 138 are modular components configured to allow convenient replacement, assembly, and/or disassembly of one or more components of the running board assembly 110.

As shown in FIGS. 3-6, the running board 116 includes a first portion (e.g., user support surface, plate, etc.), shown as an engagement interface 140, and a second portion, shown as support structure interface 142. As shown in FIG. 4, the engagement interface 140 defines a plurality of apertures, shown as running board apertures 146, along a longitudinal length of an inner edge thereof. According to an exemplary embodiment, the running board apertures 146 are configured (e.g., sized, positioned, etc.) to receive mounting fasteners to detachably couple the running board 116 to the mounting plate 125 of the mounting bracket 112.

As shown in FIGS. 3-6, the engagement interface 140 includes a plurality of strengthening structures (e.g., a pattern, a series of through-holes, a texture, or a structure, such as a honey-comb structure, etc.), show as strengthening structures 144. According to an exemplary embodiment, the strengthening structures 144 are configured to strengthen the running board 116 of the running board assembly 110 while reducing the weight thereof. As shown in FIGS. 3-6, the strengthening structures 144 have a honey-comb profile or shape, which provides properties such as high strength, energy absorbance, impact strength, and other material properties associated with honey-comb structures. Additionally, the strengthening structures 144 with honey-comb profile or shape provides optimal weight properties by providing a reduced density of the running board 116 while maintaining the desired strength properties. The profile or shape of strengthening structures 144 is further configured to optimize drainage and/or snowfall through the running board 116 of the running board assembly 110. More specifically, the strengthening structures 144 provide a series of through-holes to minimize fluid buildup and/or residual snow on the running board 116.

As shown in FIGS. 3-6, the engagement interface 140 has a plurality of raised portions or protrusions, shown as grip protrusions 145, extending in laterally spaced columns along an upper surface of the strengthening structures 144 of the running board 116. According to an exemplary embodiment, the grip protrusions 145 are configured to increase grip or traction between the engagement interface 140 and the feet of an operator of the vehicle 10. As shown, the grip protrusions 145 vary in length along the engagement interface 140. More specifically, first protrusions have a first length and second protrusions have a second, shorter length where (a) the first protrusions are positioned along at least a subset of the fore-aft portions of the strengthening structures 144 extending parallel to a longitudinal axis of the running board 116 and (b) the second protrusions are positioned along at least a subset (e.g., all) of the portions of the strengthening structures 144 oriented at an angle relative to the longitudinal axis of the running board 116. Further, third protrusions are positioned and spaced along the support structure interface 142. The third protrusions are shorter than the first protrusions. In some embodiments, the second protrusions and the third portions have the same or similar length.

As shown in FIGS. 3-6, the support structure interface 142 of the running board 116 engages the structural support 114. More specifically, the support structure interface 142 engages with the middle portion 130 of the structural support 114. As shown in FIGS. 4-6, the support structure interface 142 is configured as a curved bracket, flange, or plate extending longitudinally along an outer edge of the engagement interface 140. At least a portion of the support structure interface 142 is configured to curve around the middle portion 130 of structural support 114. In some embodiments, the support structure interface 142 is configured as a slot, channel, or tube sized to receive the middle portion 130 of structural support 114 therethrough to detachably couple the running board 116 to structural support 114. As shown in FIGS. 4-6, the support structure interface 142 defines a plurality of apertures or through-holes spaced along a length thereof (e.g., to reduce a weight of the running board 116).

As shown in FIGS. 3, 5, and 6, the toe stop 118 includes a frontmost wall, shown as kick plate 148, positioned between a first lateral wall, shown as mounting plate 150, and a second lateral wall, shown as outer plate 152; an upper plate, shown as top plate 154, extending rearward from an upper end of the kick plate 148; and a bracket, shown as mounting bracket 156, extending from a free end of the top plate 154 opposite the kick plate 148. The kick plate 148, the mounting plate 150, the outer plate 152, the top plate 154, and a portion of the running board 116 collectively define a cavity, shown as foot cavity 158, configured to receive at least a portion of an operator's foot (e.g., a toe portion). In some embodiments, one or more of the kick plate 148, the outer plate 152, and/or the top plate 154 include a textured or patterned surface, one or more slots or apertures, and/or a patterned structure (e.g., a honey-comb structure) to strengthen the toe stop 118, create traction with a portion of the user's foot, optimize drainage and/or snowfall through the toe stop 118, and/or minimize additional weight to the running board assembly 110. In some embodiments, the kick plate 148, the mounting plate 150, the outer plate 152, the top plate 154, and/or the mounting bracket 156 are integrally formed with each other (e.g., welded, bent from a single piece of metal, etc.). In some embodiments, the kick plate 148, the mounting plate 150, the outer plate 152, the top plate 154, and/or the mounting bracket 156 are individual components that are assembled or removably coupled together by one or more fasteners (e.g., bolts, screws, or other fastening agent).

As shown in FIGS. 5 and 6, each of the kick plate 148 and the outer plate 152 defines one or more running board apertures, shown as running board apertures 160, configured (e.g., positioned, sized, etc.) to receive the one or more fasteners, shown as toe stop fasteners 164. The toe stop fasteners 164 extend through the running board apertures 160 and corresponding apertures in the running board 116 to couple the toe stop 118 to the running board 116. Additionally, each of the mounting plate 150 and the mounting bracket 156 defines one or more mounting apertures, shown as toe stop mounting apertures 162, configured (e.g., positioned, sized, etc.) to receive additional toe stop fasteners 164 to couple the toe stop 118 to the body 20 and/or the frame 12 of the vehicle 10. In some embodiments, the toe stop 118 is coupled to (a) the mounting bracket 112 and (b) the body 20 and/or the frame 12 of the vehicle 10. In such embodiments, the toe stop 118 may be coupled to the mounting plate 125 by the toe stop aperture 124 of the mounting bracket 112. In some embodiments, the toe stop 118 is coupled to the running board 116 and directly to the body 20 and/or the frame 12 of the vehicle 10.

According to the exemplary embodiment described in FIGS. 1 and 3-6, the running board assembly 110 is mounted or detachably coupled to the vehicle 10. One or more components of the running board assembly 110 may be modular such that the one or more components can be individually replaced or decoupled from the running board assembly 110 and/or the vehicle 10 for convenient replacement or repair of the one or more components. In some embodiments, the mounting bracket 112 is mounted (e.g., detachably coupled) to the vehicle 10. In such embodiments, a user may couple the mounting bracket 112 to the body 20 (e.g., the tunnel) and/or the frame 12 using the mounting fasteners received by the mounting apertures 120.

Additionally, the user may detachably couple the structural support 114 to one or more of the body 20 of the vehicle 10, the frame 12 of the vehicle 10, and/or the mounting bracket 112. The user may assemble or detachably couple one or more components of structural support 114. For example, the user may couple the couple the link 138 and the front portion 128 of structural support 114. The link 138 is configured to receive the front portion 128 of structural support 114, and the linking fastener 136 is received by the linking aperture 134 to couple the link 138 to the front portion 128 of structural support 114. As another example, the user may detachably couple the rear portion 126 of structural support 114 to one or more of the mounting bracket 112, the body 20 of the vehicle 10, and/or the frame 12 of the vehicle 10. The structural support fastener may be received by the structural support aperture 122 and/or the structural support aperture 132 to couple the structural support 114 to one or more of to one or more of the mounting bracket 112, the body 20 of the vehicle 10, and/or the frame 12 of the vehicle 10.

Further, the running board 116 may engage, be supported by, and/or removably coupled to the middle portion 130 of structural support 114. The running board 116 may engage, be supported by, and/or removably coupled to the mounting plate 125 of the mounting bracket 112. For example, the user may position the running board 116 along the mounting plate 125 and the middle portion 130 of structural support 114. The user can then secure the running board 116 by detachably coupling the running board to the mounting plate 125 using fasteners extending through the running board apertures 146 and corresponding apertures of the mounting plate 125.

Further, the toe stop 118 may engage, be supported by, and/or removably coupled to the running board 116, the body 20 of the vehicle 10, and/or the frame 12 of the vehicle 10. The toe stop 118 may be coupled to the running board 116 by the toe stop fasteners 164 extending through the running board apertures 160 of the toe stop 118 and corresponding apertures of the running board 116. The toe stop 118 may be coupled to the mounting bracket 112 by the toe stop fasteners 164 extending through the running board apertures 160 of the toe stop 118 and the toe stop aperture 124 of the mounting plate 125. The toe stop 118 may be coupled to the body 20 and/or the frame 12 of the vehicle 10 by the toe stop fasteners 164 extending through the toe stop mounting apertures 162 of at least one of the mounting plate 150 or the mounting bracket 156 of the toe stop 118.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, the running board assembly 110, etc.) as shown in the various exemplary embodiments is illustrative only. Additionally, any element disclosed in one embodiment may be incorporated or utilized with any other embodiment disclosed herein.

1. A running board assembly for a snowmobile, the running board assembly comprising:
a mounting bracket configured to detachably couple to a first portion of the snowmobile;
a support having a first end, a second end, and a running board interface positioned between the first end and the second end, the first end detachably coupled to the mounting bracket, the second end configured to detachably couple to a second portion of the snowmobile; and
a running board detachably coupled to and supported by the mounting bracket and the running board interface of the support, the running board having a support surface defining a plurality of apertures forming a honey-comb shaped profile.

2. The running board assembly of claim 1, wherein the running board includes a flange positioned along a lateral edge of the support surface, the flange configured to engage with the running board interface of the support.

3. The running board assembly of claim 2, wherein the support has a tubular structure, and wherein the flange has a curved profile that corresponds with a shape of the tubular structure.

4. The running board assembly of claim 2, wherein the plurality of apertures is a first plurality of apertures, and wherein the flange defines a second plurality of apertures spaced along a longitudinal length thereof.

5. The running board assembly of claim 2, wherein the running board includes a plurality of protrusions spaced along a longitudinal length of and extending upward from the flange.

6. The running board assembly of claim 1, wherein the running board includes a plurality of protrusions extending upward from the support surface.

7. The running board assembly of claim 6, wherein the plurality of protrusions includes first protrusions having a first length and second protrusions having a second length different from the first length.

8. The running board assembly of claim 7, wherein the first protrusions are positioned along first portions of the support surface that extend parallel to a longitudinal axis of the running board, and wherein the second protrusions are positioned along second portions of the support surface oriented at an angle relative to the longitudinal axis of the running board.

9. The running board assembly of claim 1, wherein the running board is manufactured from extruded aluminum.

10. The running board assembly of claim 1, further comprising a toe stop detachably coupled to the running board and configured to detachable couple to a third portion of the snowmobile.

11. A running board assembly comprising:
a mounting bracket configured to detachably couple to a first portion of a vehicle;
a support having a first end, a second end, and a running board interface positioned between the first end and the second end, the first end detachably coupled to the mounting bracket, the second end configured to detachably couple to a second portion of the vehicle; and
a running board includes a support surface and a flange positioned along a lateral edge of the support surface, the support surface configured to detachably couple to the mounting bracket and the flange configured to engage with the running board interface of the support;
wherein the running board includes a first plurality of protrusions spaced along a longitudinal length of and extending upward from the flange; and
wherein the running board includes a second plurality of protrusions extending upward from the support surface.

12. The running board assembly of claim 11, wherein the support surface defines a plurality of apertures forming a honey-comb shaped profile.

13. The running board assembly of claim 11, wherein the flange defines a plurality of apertures spaced along the longitudinal length thereof.

14. The running board assembly of claim 11, wherein the second plurality of protrusions includes first support surface protrusions having a first length and second support surface protrusions having a second length different from the first length.

15. The running board assembly of claim 14, wherein the first support surface protrusions are positioned along first portions of the support surface that extend parallel to a longitudinal axis of the running board, and wherein the second support surface protrusions are positioned along second portions of the support surface oriented at an angle relative to the longitudinal axis of the running board.

16. The running board assembly of claim 11, wherein the running board is manufactured from extruded aluminum.

17. The running board assembly of claim 11, further comprising a toe stop detachably coupled to the running board and configured to detachable couple to a third portion of the vehicle.

18. A running board assembly comprising:
a mounting bracket configured to detachably couple to a first portion of a vehicle;
a support having a first end, a second end, and a running board interface positioned between the first end and the second end, the first end detachably coupled to the mounting bracket, the second end configured to detachably couple to a second portion of the vehicle;
a running board detachably coupled to and supported by the mounting bracket and the running board interface of the support, the running board having a support surface defining a plurality of apertures forming a honey-comb shaped profile; and
a toe stop detachably coupled to the running board and configured to detachably couple to a third portion of the vehicle.

19. The running board assembly of claim 18, wherein the running board includes a plurality of protrusions extending upward from the support surface, wherein the plurality of protrusions includes first protrusions having a first length and second protrusions having a second length different from the first length, wherein the first protrusions are positioned along first portions of the support surface that extend parallel to a longitudinal axis of the running board, and wherein the second protrusions are positioned along second portions of the support surface oriented at an angle relative to the longitudinal axis of the running board.

20. The running board assembly of claim 19, wherein the running board includes a flange positioned along a lateral edge of the support surface, wherein the flange is configured to engage with the running board interface of the support, and wherein the running board includes a third plurality of protrusions spaced along a longitudinal length of and extending upward from the flange.
